(19) United States
(12) Patent Application Publication
(10) Pub. No.: US 2005/0097189 A1
(43) Pub. Date: May 5, 2005

(54) Automatic detection and dialing of phone numbers on web pages

(75) Inventor: Ramanujan Kashi, Bridgewater, NJ (US)

Correspondence Address: COHEN, PONTANI, LIEBERMAN & PAVANE, 551 FIFTH AVENUE, SUITE 1210, NEW YORK, NY, 10176, US

(73) Assignee: Avaya Technology Corp.

(21) Appl. No.: 10/697,468

(22) Filed: Oct. 30, 2003

(51) Int. Cl. G06F 15/16

(52) U.S. Cl. 709/217

(57) ABSTRACT

Relevant and useful types of data, such as telephone numbers, are identified and highlighted on a downloaded web page in a web browser. The browser user may click on a particular instance of the type of data highlighted in order to perform an activity or operation with it, such as, in the case of a highlighted telephone number, dialing the telephone number, or storing it in an address book.

### BACKGROUND OF THE INVENTION

1. Field of the Invention

The present invention relates generally to browsers and browser functionality, and, specifically, to providing web browsers with the capability and Graphical User Interface (GUI) functionality for simplifying and enabling telephone connections directly from a computer.

2. Description of the Related Art

The technology of computing and the technology of communication have been going through a process of merging together—a process in which the distinctions between the technologies of the telephone, the television, the personal computer, the Internet, and the cellular phone are increasingly blurred, if not meaningless. The functionalities of what were once separate devices are now freely shared between and among devices. One's cellular phone can surf the Internet, while one's personal computer (PC) can make telephone calls. Part of this synergistic merging and growth of technology is the rapidly expanding use of the “browser” for accessing any type of data, or performing any type of activity.

The public was introduced to the “web browser” in the form of Netscape Navigator™ in the mid-1990's. The ancestor of the Netscape Navigator™ was the NCSA Mosaic, a form of “browser” originally used by academics and researchers as a convenient way to present and share information. At that point, the web browser was basically a relatively small program one could run on one's PC that made the accessing and viewing of information and media over a network relatively easy (and even pleasant). With the establishment of a common format (HTML—Hypertext Markup Language) and communication protocol (HTTP—Hypertext Transport Protocol), anyone could make a “web page” residing on the World Wide Web, a web page that could be transmitted, received, and viewed on any web browser. Web browsers rapidly grew into a new form of entertainment media, as well as an seemingly limitless source of information and, for some, self-expression. The Internet, a vast worldwide collection of computer networks linked together, each network using the IP/TCP (Internet Protocol/Transmission Control Protocol) suite to communicate, experienced exponential growth because of its most popular service—the World Wide Web.

Current web browsers, such as Safari (from Apple), Internet Explorer (from Microsoft), Mozilla, Opera, etc., serve as the gateway for many people to their daily source of news, information, and entertainment. Users “surf the Web”, i.e., download data from different sources, by entering URLs (Uniform Resource Locators) that indicate the location of the data source. In this application, URLs are considered in their broadest aspect, as addresses for data sources where the address may indicate a web server on the Internet, a memory location of another PC on a local area network (LAN), or even a driver, program, resource, or memory location within the computer system that is running the web browser. Most web browsers simplify the process of entering the URL by saving “bookmarks” that allow the user to navigate to a desired web page by simply clicking the bookmark. In addition, a user may click on a hyperlink embedded in a web page in the web browser in order to navigate to another web page.

As stated above, web pages are transmitted and received using HTTP, while the web pages themselves are written in HTML. The “hypertext” in HTML refers to the content of web pages—more than mere text, hypertext (sometimes referred to as “hypermedia”) informs the web browser how to rebuild the web page, and provides for hyperlinks to other web pages, as well as pointers to other resources. HTML is a “markup” language because it describes how documents are to be formatted. Although all web pages are written in a version of HTML (or other similar markup languages), the user never sees the HTML, but only the results of the HTML instructions. For example, the HTML in a web page may instruct the web browser to retrieve a particular photograph stored at a particular location, and show the photograph in the lower left-hand corner of the web page. The user, on the other hand, only sees the photograph in the lower left-hand corner.

As mentioned above, web browsers are undergoing a transformation from being a means for browsing web pages on the World Wide Web to a means for accessing practically any type of data contained in any type of storage location accessible by the browser. On a mundane level, this can be seen in new versions of popular computer operation systems, such as Microsoft Windows, where the resources on the computer are “browsed” using Windows Explorer, which behaves essentially as a browser (i.e., it uses the same control features: “back” and “forward” buttons, hyperlinks, etc.), or at large corporations where employees access company information, reports, and databases using their web browsers on the corporation's intranet.

On a more elevated level, the transformation of browsers can be seen in the planned growth from HTML to XHTML, in which HTML becomes just a variant of XML (eXtensible Markup Language). A simple way to understand the difference between the two markup languages is that HTML was designed to display data and focus on how data looks, whereas XML was designed to describe data and focus on what data is. The two markup languages are not opposed, but complementary. XML is a universal storage format for data, any type of data, and files stored in XML can be ported between different hardware, software, and programming languages. The expectation is that most database records will be translated into XML format in the coming years.

It is expected that browsers will become universal portals into any type of stored data, any form of communication and/or entertainment. And, as mentioned above, as technologies merge, browsers will be used more and more as the means for interacting with our devices, tools, and each other.

Therefore, there is a need for systems and methods that can aid in this merging of technologies; and, in particular, systems and methods that help the browser user interact seamlessly with the browser and, through the browser, with any devices and/or technologies connected to the computer system on which the browser is running.

### SUMMARY OF THE INVENTION

One object of the present invention is to provide a system and method for allowing the browser user to interact seamlessly with other devices and/or technologies connected to the computer system on which the browser is running.

Another object of the present invention is provide a system and method for identifying relevant and/or useful data types of a downloaded document, and for highlighting any instances of the relevant and/or useful data type in the document as displayed in the web browser.

Yet another object of the present invention is to provide a system and method for the user to simply and easily apply instances of relevant types of data in a downloaded document to their appropriate use and/or transmit them to an appropriate location.

Still another object of the present invention is to provide a system and method for a web browser to identify and highlight all telephone numbers in a downloaded web page, as well as make the highlighted telephone numbers clickable, so that clicking upon a highlighted telephone number results in the clicked telephone number being dialed, being stored, or being transmitted.

These and other objects are substantially achieved by the present invention, which provides a system and method for (a) the automatic detection of particular types of information when present in a document (e.g., web page) being loaded into a browser (e.g., a web browser); (b) the changing of the appearance of any detected instances of the particular types of information on the loaded document so as to call the attention of the viewer (i.e., the browser user) to them; and (c) the performing, or initiating, a desired operation upon any of the instances of the particular types of information on a loaded document with only one or two actions on the viewer/user's part. Such desired operations may include at least one of the following: storing the detected instances of the particular types of information in memory locations designated for those types of data; transmitting the detected instances of the particular types of information to a designated piece of hardware or software in order that the designated piece of hardware/software perform a desired action either with the detected instances or upon the detected instances; and providing the user/viewer with a number of options of what action to perform with or upon the detected instances.

In the presently preferred embodiment of the present invention, telephone numbers on downloaded web pages are detected and highlighted when displayed in the web browser. The user may click on one of the highlighted telephone numbers to perform some sort of action upon it, e.g., initiate a telephone call, store the telephone number in an address book, or place it in temporary storage for immediate retrieval.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a flowchart showing a method of detecting specific types of data and providing user functionality for the detected instances of the specific types of data according to a general conceptual embodiment of the present invention;

FIG. 2 is a flowchart showing schematically a general method of auto-detection, highlighting, and providing user functionality according to a presently preferred embodiment of the present invention;

FIGS. 3A-3E illustrate an exemplary embodiment of a web browser GUI while performing some of the steps in the method of FIG. 2 according to the presently preferred embodiment;

FIGS. 4A-4B show a flowchart of the steps performed in a specific Internet Explorer/Windows implementation of the presently preferred method of FIG. 2; and

FIG. 5 shows the components used in the specific Internet Explorer/Windows implementation in FIG. 4A of the presently preferred method of FIG. 2.

### DETAILED DESCRIPTION OF THE PRESENTLY PREFERRED EMBODIMENTS

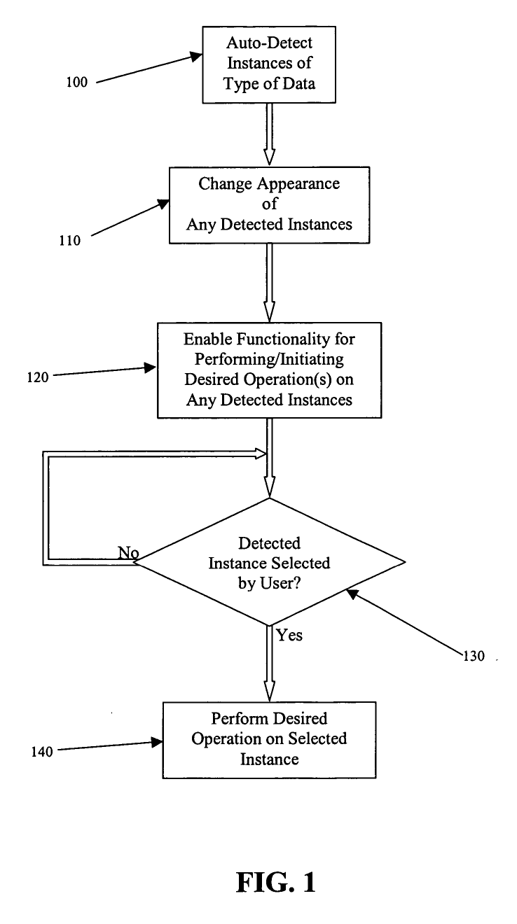

FIG. 1 is a flowchart showing a method of detecting specific types of data and providing user functionality for the detected instances of the specific types of data according to a general conceptual embodiment of the present invention. In step 100, the present system and method automatically detects particular types of information when present in a document being loaded into a browser. In step 110, the appearance of any detected instances of the particular types of information in the loaded document is changed so as to call the attention of the browser user to them. In step 120, the functionality for performing, or initiating, at least one desired operation upon any of the highlighted instances of the particular types of information on a loaded document is provided.

In step 130, it is determined whether the user has selected a highlighted instance of the specified data type. If the user has selected a highlighted instance of the specific data type (thus indicating a desire to use the provided functionality) in step 130, the desired operation is performed with or upon the selected highlighted instance of the specified data type in step 140. As indicated above, there may be more than one desired operation performed in this step. Thus, a desired operation may be performed with or upon an instance of a specified data type in response to as few actions as a single action performed by the user.

Desired operations to be performed on the instances of the specific data type may include at least one of: storing the detected instances of the particular types of information in memory locations designated for those types of data; transmitting the detected instances of the particular types of information to a designated piece of hardware or software in order that the designated piece of hardware/software perform a desired action either with the detected instances or upon the detected instances; and providing the user/viewer with a number of options of what action to perform with or upon the detected instances.

The specific data types that are automatically detected, highlighted, and provided with the functionality that they may be selected by the user of the browser for a desired operation, according to the embodiments of the present invention, include, for example, telephone numbers, mailing addresses, categories of words, icons, images, or embedded files, and specific details within specific file types (e.g., an attribute of an audio or picture file).

In the presently preferred embodiment of the present invention, telephone numbers are detected on web pages being loaded into a web browser, any detected telephone numbers are highlighted on the loaded web page in the browser, and the browser user/viewer may left-click upon any highlighted telephone number in order to initiate a call to the telephone number, or right-click upon it in order to view a menu of options of what action to take with or upon the telephone number. In this context, “left-click” and “right-click” refer to a computer user placing a cursor over a specific area on a computer screen and depressing either a left-hand button or a right-hand button, respectively, on a computer ‘mouse’. In other embodiments, there may be only one button on the computer mouse, and, instead of a right-click and a left-click, the user may depress the single mouse button either once or twice in rapid succession to indicate either making a call or seeing a menu of choices, respectively. Furthermore, in less preferred embodiments, the user may have a means that can only indicate a single type of selection, in which case the user will preferably be presented with a menu of choices. Although the presently preferred embodiment is described in terms of a right- and left-click mouse, any means of selecting an item on the computer screen may be used by the user, for example, a touchpad, a keyboard, a joystick, voice command, etc., as would be understood by one skilled in the art.

In terms of the client-server architectural model, the present invention should be understood as being implemented on the client side. To be more exact, the steps of auto-detecting 100, changing appearance 110, enabling functionality 120, and, when a user selects an auto-detected instance 130, performing one or more desired operations 140, are not being performed by the server which is providing the document to the browser client. In the preferred embodiment, the browser client (and modules interacting with the browser client) perform the steps of the present invention. However, it should be noted that it is possible for a proxy server located between the browser client and the server providing the document to the browser client to perform some or all of the method steps in accordance with another embodiment of the present invention. For example, in an organization having an intranetwork and a connection to the Internet, a centralized proxy server could perform steps 100, 110, and 120 on web pages being downloaded into browser clients on individual employee's computers.

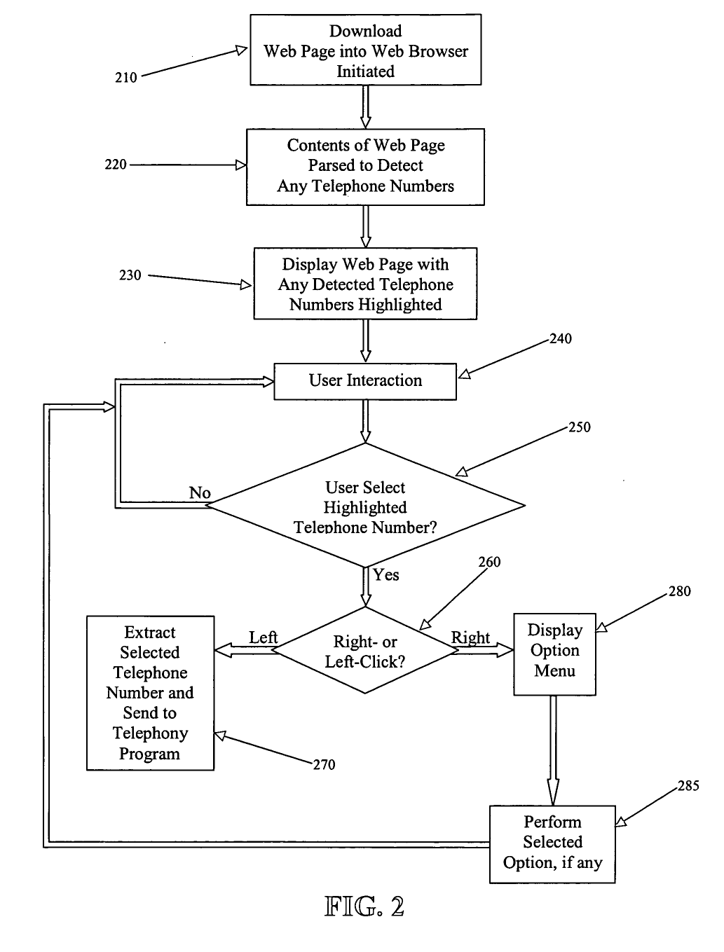

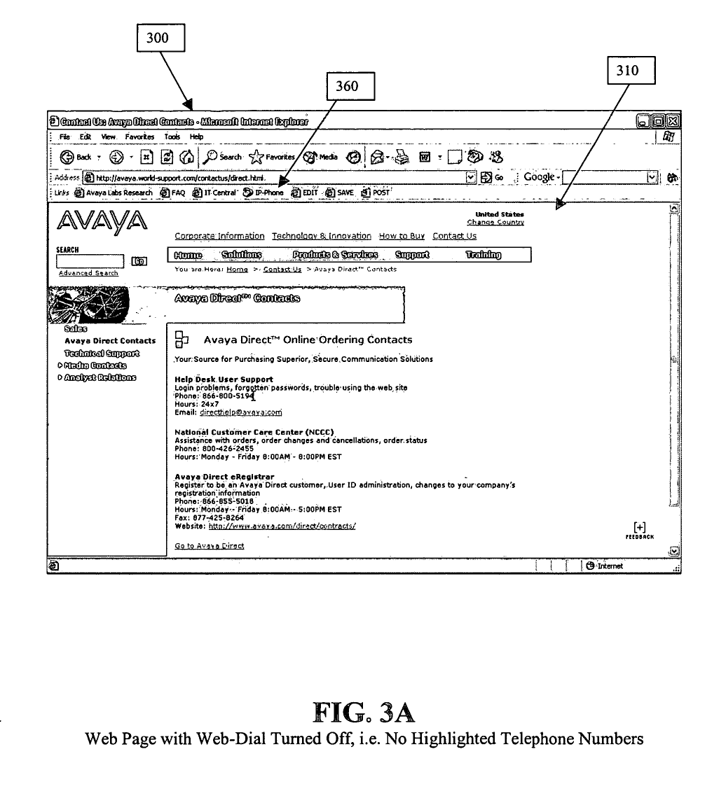

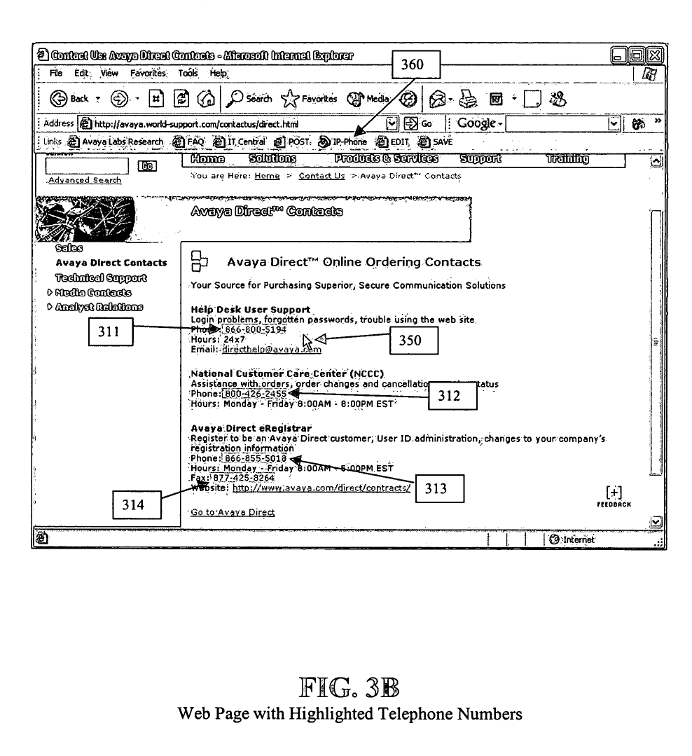

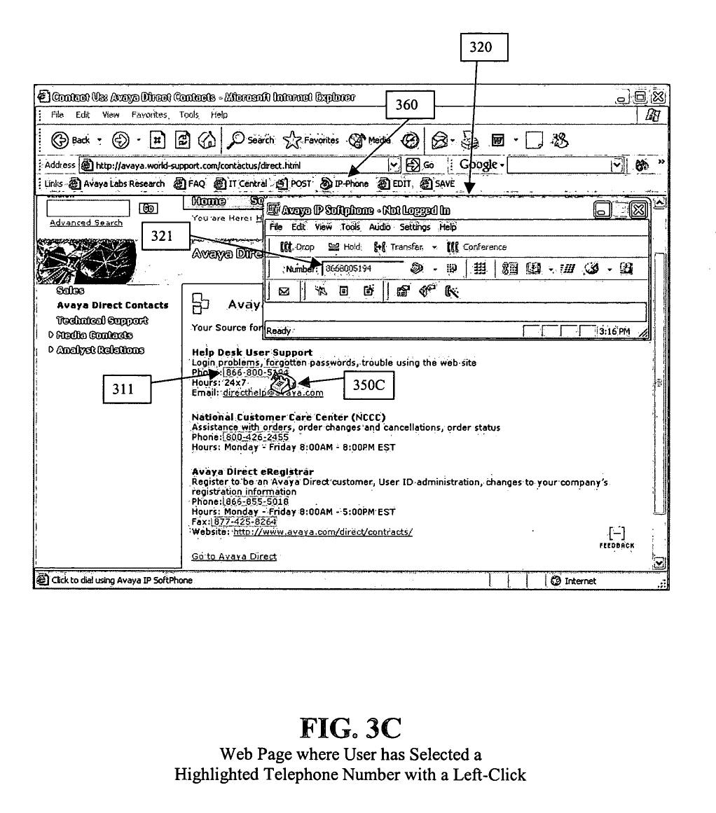

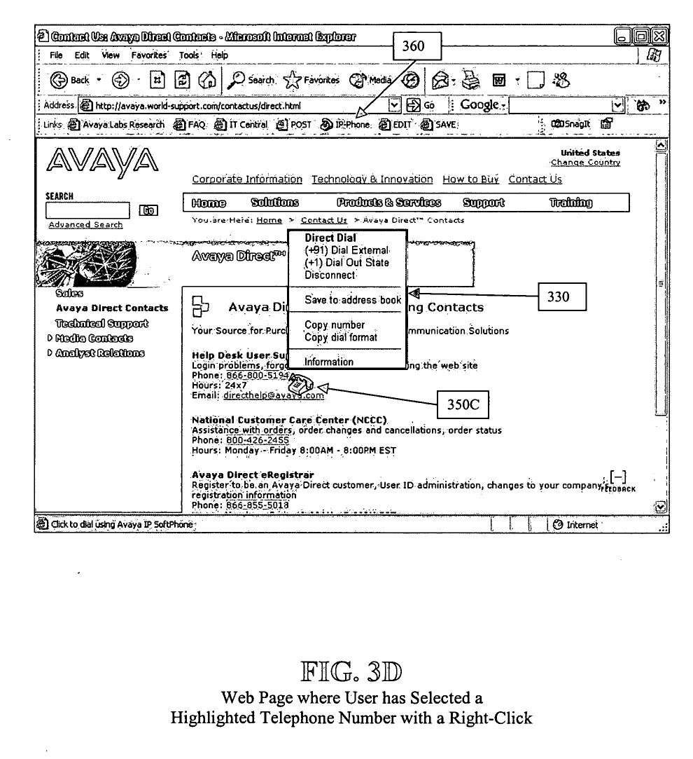

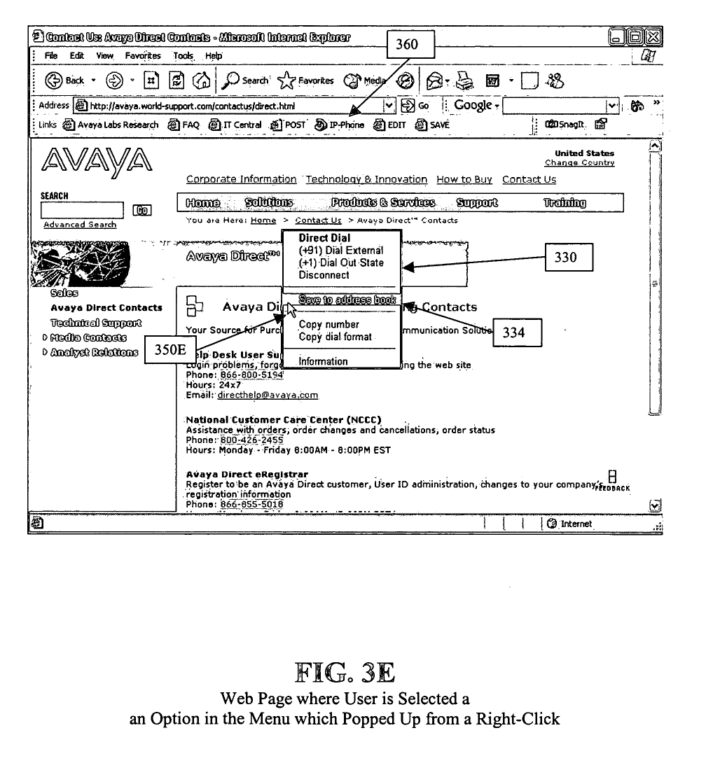

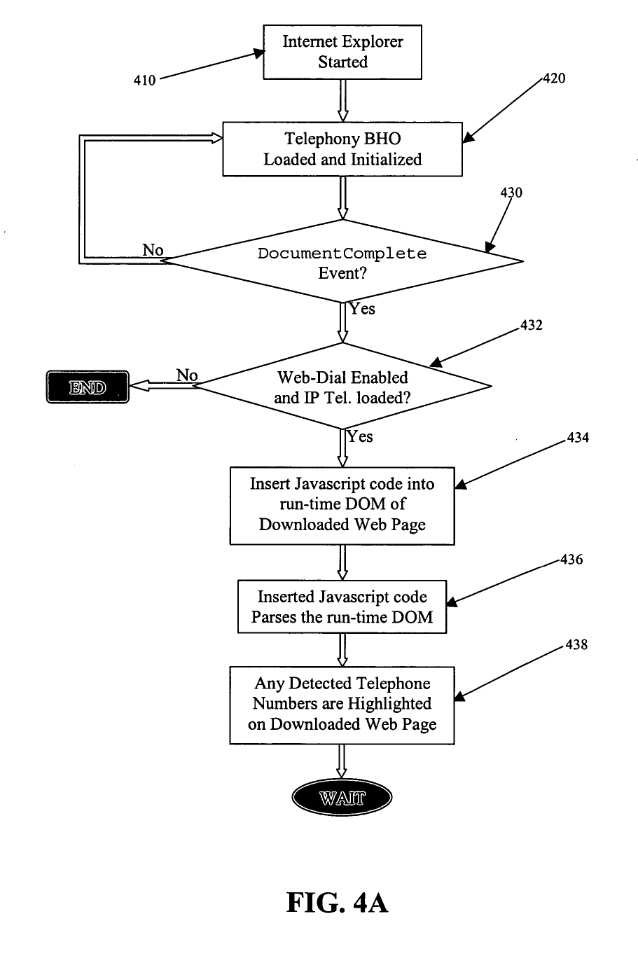

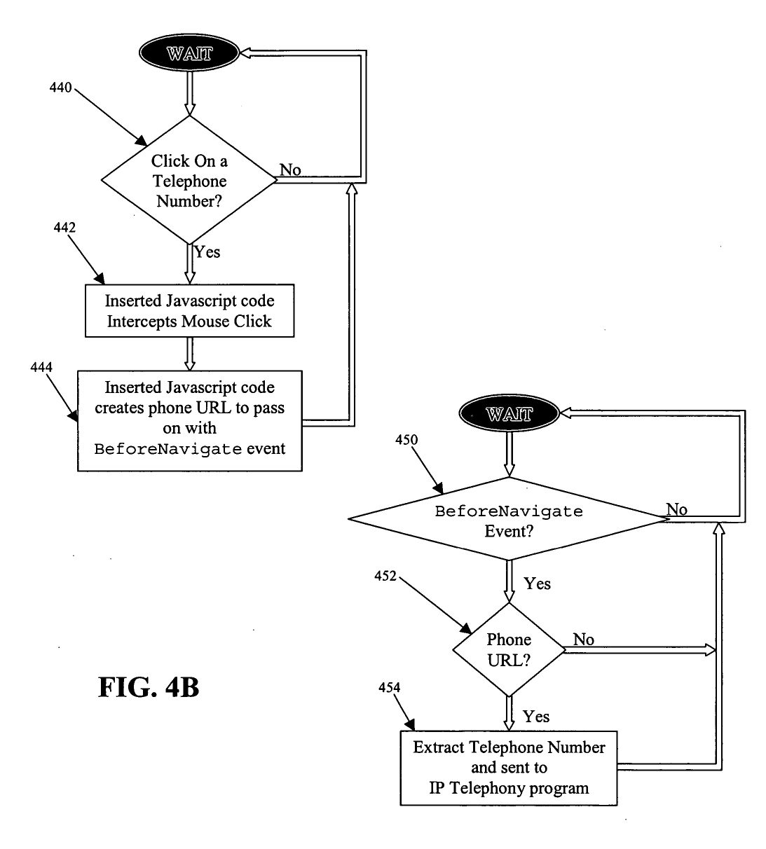

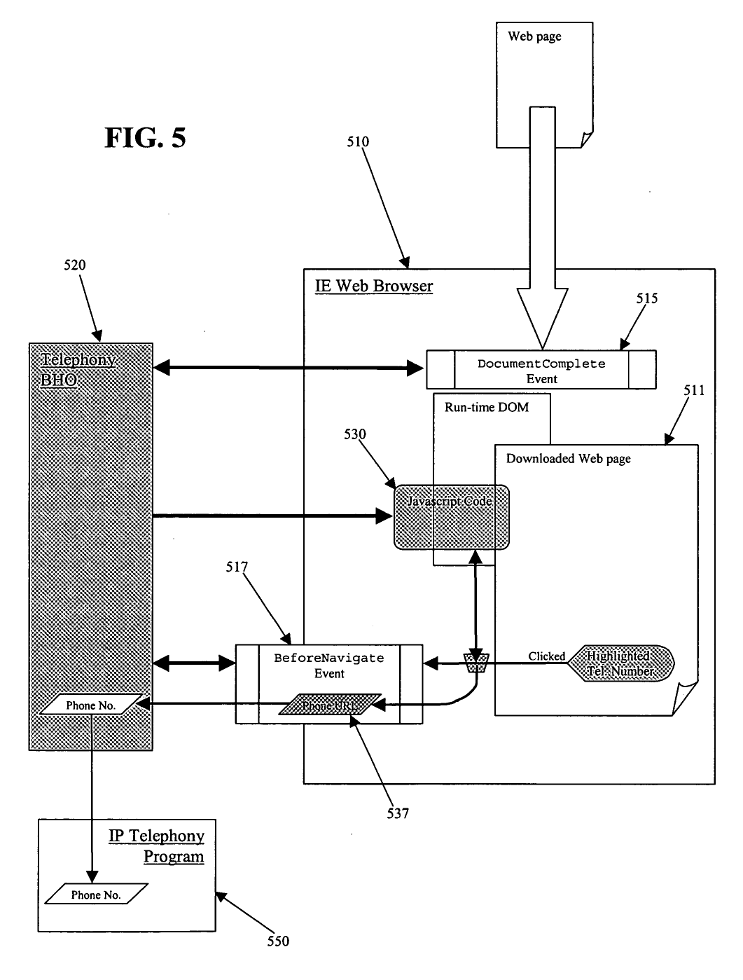

The method according to the presently preferred embodiment will be generally, i.e., conceptually, described with reference to the flowchart in FIG. 2, while an exemplary embodiment of how the web browser GUI would appear to the user is shown in FIGS. 3B-3E. After this general description, a specific implementation of the presently preferred embodiment will be described with reference to FIGS. 4-5. It should be understood that FIG. 2 is a general schematic flowchart of the conceptual steps in the presently preferred embodiment; thus, the steps therein may be performed in a different order, or some steps may be combined or a single step separated into two or more parts. In other words, the present invention is not intended to be limited to the order, the number, or overall structure of steps in FIG. 2. Furthermore, the appearance of the exemplary web browser GUI in FIGS. 3B-3E is not intended to limit the present invention in any way, shape, or form.

In FIG. 2, we are assuming the web browser is already loaded and working on a computer. In step 210, the download of a web page into the web browser has been initiated. In most instances, this would first occur when the user opens, or starts, the web browser, because most web browsers, including Internet Explorer, open a “home page” immediately upon start up (without any user action). Afterwards, this would occur whenever the user enters a URL to go to, or when the user selects a link, etc. In step 220, the contents of the web page are parsed, i.e., the web page is broken down and analyzed so that telephone numbers are detected. In step 230, the web page is displayed in the web browser to the user with any detected telephone numbers highlighted. In step 240, the user interacts with the web page; such interaction includes, of course, merely viewing or reading the contents of the downloaded web page. While the user is interacting with the web page, user input actions are monitored to determine whether the user has selected a highlighted telephone number in step 250.

If the user has selected a highlighted telephone number, it is determined whether the user indicated a right-click or a left-click in step 260. If the user has performed a left-hand click selection, then the telephone number is extracted and sent to another program in step 270. The other program may be, for example, a program for performing IP telephony, or a program for auto-dialing a telephone number. In this step, the other program may need to be initiated or loaded by the presently preferred embodiment. If the user has performed a right-click selection, then a menu of options is displayed to the user in step 280. This menu of options may include the option of automatically calling the telephone number with the program in step 270. Other options include changing the telephone number (e.g., adding a prefix for an international call or for getting a direct line out of an office) and then auto-dialing it, saving the telephone number to a specific place (e.g., an address book), saving it to the computer clipboard, etc. The selected action (or no action at all, if no action was selected) is performed in step 285.

After either the appropriate left-click or right-click action is performed in steps 270 or step 285, respectively, the process returns to monitoring in the loop of steps 240 and 250. At any time during the method in FIG. 2, of course, the user may jump to another website, thereby initiating a web page download and returning the process to step 210. This is not shown in FIG. 2 because it is not necessarily connected with the presently preferred embodiment of the present invention, although, as we will see below, the implementation of the presently preferred embodiment in FIGS. 4-5 uses the indication of a page jump as monitoring step 250.

In FIGS. 3A-3E, we see an exemplary embodiment of how a web browser GUI according to the presently preferred embodiment would appear as some of the steps in the method of FIG. 2 are performed.

In FIG. 3A, a screen shot of a GUI window 300 of a standard web browser (in this case, Internet Explorer) is shown with a loaded web page 310. In FIG. 3A, there is a ‘bookmarklet’ 360 labeled “IP-Phone” in the Links toolbar at the top of the web browser GUI; this bookmarklet 360 can be used to turn the Web-Dial functionality on or off. Because the Web-Dial functionality is turned off, the telephone numbers on web page 310 are not highlighted or indicated in any way. Thus, web page 310 in FIG. 3A appears as it would appear in a standard, prior art web browser.

By contrast, FIG. 3B shows the same web page 310 in the GUI window after the Web-Dial functionality has been turned on. Because the Web-Dial functionality has been turned on, web page 310 has been parsed according to steps 210 and 220 in FIG. 2 and the telephone numbers that were detected in step 220 are highlighted in FIG. 3B according to step 230 in FIG. 2. Specifically, four telephone numbers 311, 312, 313, and 314 on the web page can be seen highlighted. Cursor 350 can also be seen over the web page in FIG. 3B.

In FIG. 3C, the user has moved cursor 350 to highlighted telephone number 311. According to the presently preferred embodiment, when the cursor is located over the span of a highlighted telephone number, it changes from its usual arrow shape to an icon of a telephone, as can be seen from cursor 350C in FIG. 3C. The telephone icon was chosen in the presently preferred embodiment in order to indicate what operation would be performed if the highlighted telephone number was clicked, namely, the number would be called. In other embodiments, the icon would be changed to suit whatever operation is performed upon clicking. For example, if the highlighted telephone number was stored in an address book when the user clicked on it, an icon of a book could be displayed when the cursor is over the highlighted telephone number. There are many variations upon this as is well known to one skilled in the art.

The user has also performed a left-click in FIG. 3C, for we can see a new window 320 showing an IP telephony program. Thus, in FIG. 3C, the presently preferred embodiment has already performed step 270, in which highlighted telephone number 311 was extracted and sent to the IP telephony program, and now the extracted telephone number can be seen in box 321 in IP telephony window 320.

In contrast to the left-click selection of FIG. 3C, the user in FIG. 3D has performed a right-click selection of highlighted telephone number 311, thereby causing menu 330 to pop up, in accordance with step 280 in FIG. 2. Although menu 330 is shown immediately above cursor 350C in FIG. 3D, menu 330 may appear anywhere on the computer screen. The options presented to the user in pop up menu 330 of FIG. 3D are “Direct Dial”, “(+1) Dial External”, “(+1) Dial Out State”, “Disconnect”, “Save to address book”, “Copy number”, “Copy dial format”, and “Information”. The first three options are self-explanatory.

“Disconnect” lets the user disconnect the phone line after a telephone call. This function would be grayed-out when the user initially selects the highlighted telephone number, as there would be no connection yet. Of course, it is possible that after finishing a call using the IP telephony program, the user may disconnect using the IP telephony program. “Copy number” copies the number into the computer's clipboard for later use by the user. “Copy dial format” indicates that the format of the highlighted telephone number is a format that should be searched for in the future when step 220 is performed. “Information” provides information about the web-dial functionality.

The “Copy Dial Format” function brings up another feature of the present invention—the ability to learn. According to certain embodiments, the present invention can receive feedback from the user and then use that feedback in order to modify or add to the search method used to detect any instance of the specified data type.

In FIG. 3E, the user has moved cursor 350E into the options listed in popup menu 330, and appears to be selecting the “Save to address book” option 334. It should be understood that the user options shown in the pop-up menu of this exemplary GUI are exemplary, and that many variations regarding the options are possible: there may be greater or fewer options, or different options, such as reverse telephone number lookup, which would access a reverse phone lookup directory to verify or to obtain the address and name associated with the highlighted telephone number.

In FIGS. 3B, 3C, 3D, and 3E, the Web-Dial functionality is turned on, and, thus, each occurrence of a telephone number is highlighted. However, a user may wish to turn off the Web-Dial functionality in order to not have all instances of telephone numbers highlighted (as is shown in FIG. 3A).

Furthermore, the browser user may manually select a telephone number and pass the telephone number to the IP telephony program (or perform other operations upon or with the telephone number, such as store it in an address book). To do so, the browser user would use the cursor to select the numbers on the web page, and then use the cursor to click bookmarklet 360, which causes, in the presently preferred embodiment, the telephone number to be sent to the IP telephony program and the IP telephony window 320 to pop up. This manual selection is provided for those cases where the telephone numbers are not identified on the web page (and thus are not clickable), or in case a telephone number has been saved in temporary memory (such as the computer clipboard) and now the user wishes to dial it, or when the user has turned off the Web-Dial functionality.

FIGS. 4A and 4B provide specific details of an Internet Explorer/Windows implementation of the presently preferred embodiment. It should be noted, however, that the present invention is by no means limited to either the Microsoft Windows operating system or the Internet Explorer web browser. Other embodiments may be implemented in other web browsers, such as Netscape Navigator, Apple's Safari, Mozilla, Opera, etc. Furthermore, the browser may be running over a system running any operating system, such as the Apple Mac OS, the Linux operating system, or any of the flavors of UNIX offered by the larger computer system designers (e.g., Solaris on Sun computer systems; Irix from Silicon Graphics, etc.). In other words, the present invention is platform-independent. Furthermore, it is contemplated that, as discussed in the Background section, future browsers will be more than merely web browsers, but rather portals to any type of data and even active files (executables), as well as a powerful processing means (or framework) for acting upon data. The present invention is intended to be implemented in such browsers as well.

FIGS. 4A-4B show a flowchart of the method steps performed in the specific Internet Explorer/Windows implementation of the presently preferred method of FIG. 2, and FIG. 5 shows the components used in the method of FIGS. 4A-4B.

In step 410 of FIG. 4A, Internet Explorer is started. As Internet Explorer starts up, it also loads and initializes the Telephony Browser Helper Object (BHO) in step 420. A BHO is a Dynamic Linked Library that is loaded whenever a new instance of Internet Explorer is started. Such objects run in the same memory context as the web browser and can perform any action on the available windows and modules. In some versions of the Windows operating system, the BHOs are also loaded each time there is a new instance of Windows Explorer, Microsoft's browser for viewing the memory contents of the computer system. The BHOs are unloaded when the instance of Internet Explorer (IE) or Windows Explorer is destroyed.

In the specific implementation of the presently preferred embodiment, the Telephony BHO listens for events occurring in the web browser. Specifically, the Telephony BHO listens for two events that are fired by IE at specific times: the DocumentComplete event which is fired when a web document, with all of its forms, has fully loaded into the browser; and the BeforeNavigate event which is fired when the user has performed an action which seems to require that a new web document be loaded into the web browser. Such user actions include clicking the Back or Forward buttons, or entering a new URL into the navigation bar.

In step 430, the BHO is monitoring for a DocumentComplete event. If such an event is detected, the BHO determines whether the IP telephony program is loaded and that the Web-Dial functionality has been turned on in step 432. In other embodiments, it would be determined whether another type of program, such as a calendar or address book program, is loaded, if those embodiments used the other type of program. In the description of FIGS. 3A-3E above, the user turned the Web-Dial functionality on and off using bookmarklet 360; however, the Web-dial functionality may be enabled and/or turned on and off by a variety of means, as would be known to one of ordinary skill in the art. For example, the user may indicate a preference for having the Web-Dial functionality always turned on, either in this or another program, and then that preference is filed in the registry. Step 432 is not strictly necessary, and could either be left out of other implementations or be used to perform another task, such as starting the IP telephony program. In this specific implementation, if it is determined that the IP telephony program is loaded and the web-dial feature is enabled in step 432, the process continues. If not, the process stops.

If the process continues, the Telephony BHO inserts Javascript code into the run-time Document Object Model (DOM) of the downloaded document and calls the entry point of the script functionality (specifically, Telephony BHO calls a mainFuncFN( ) function of the Javascript code) at step 434. In step 436, the inserted Javascript code parses the run-time DOM of the downloaded document, looking for any pattern of numbers that appear to comprise a telephone number. Specifically, the mainFuncFN( ) function in the Javascript code calls the parsePhoneNums( ) function which performs the parsing. In step 438, any pattern of numbers in the downloaded document that appear to be telephone numbers are highlighted and made clickable.

Steps 434-438 are performed using the DOM functionality present in web browsers. The Document Object Model (DOM) is a platform- and language-neutral application programming interface (API) standard that allows programs and scripts to dynamically access and update the content, structure, and style of documents (both HTML and XML). Using the DOM API, the document can be further processed and the results of that processing can be incorporated back into the presented page. In essence, the DOM API provides a tree-like model, or framework, of the objects in a document, i.e., when an XML/HTML document is loaded into an application (such as a web browser like Internet Explorer), the DOM API creates a DOM of the downloaded document in the form of an in-memory tree representation of the objects in that document. Using the DOM API, the run-time DOM may be used to access, traverse (i.e., search for particular objects), and change the content of the downloaded document.

In steps 434-438, the components of the specific implementation of the presently preferred embodiment navigate, using the DOM API, the downloaded document and search for phone numbers in the downloaded document. In step 434, the Telephony BHO inserts the Javascript code into the run-time DOM of the downloaded document, and the Javascript code parses the objects in the run-time DOM to find if any objects in the downloaded document are phone numbers (this will be described more fully below). When a phone number is found, a span tag is created and inserted around the phone number in the downloaded document. The span tag is used in HTML to group inline-elements together in order to apply specific style and/or event attributes to the elements within the “span”. In this case, the span tag indicates that the grouped elements, i.e., the numbers making up the phone number, will be highlighted and active upon certain cursor events. Specifically, when the cursor is over the highlighted area, the cursor turns into a telephone icon (as shown in FIG. 3C); when the highlighted phone number is left-clicked, it is interpreted as a hyperlink click which is intercepted by another piece of the Javascript code and the Telephony BHO and results in the IP telephony program being called; and, when the highlighted phone number is right-clicked, the menu 330 of options in FIGS. 3D and 3E pops up.

After the initial loading and parsing of the document, the Javascript code and the BHO wait for the user to take some action, i.e., they wait for an event to occur, as shown in FIG. 4A. Their wait continues on FIG. 4B. In FIG. 4B, if a click is made over one of the phone number span tags in step 440, the Javascript code intercepts the mouse click, which is interpreted as a navigation click, in step 442. Then, a function in the Javascript code entitled dial( ) is called in step 444. The dial( ) function creates a new type of URL in accordance with the specific implementation of the presently preferred embodiment. The inventive format of this new “phone” URL comprises “phone://<stripped telephone number>”. This phone URL is captured by the BeforeNavigate event that is caused by the user's mouse click on the highlighted telephone number. In other words, the mouse click is interpreted by the web browser as a navigation event, i.e. a call to load another web page, and thus the web browser begins the process of navigating to the page indicated by the mouse click, but instead of a conventional URL, a URL (created by the Javascript code) in the new inventive phone URL format is captured. Thus, it can be seen that the specific implementation of the presently preferred embodiment uses the normal functions and events (e.g., the DocumentComplete and BeforeNavigate events) of the web browser in a new, inventive manner in order to provide some of the features of the present invention.

In a previous implementation, the dial( ) function also stripped the number string that made up the highlighted telephone number of any separator characters, such as spaces, parentheses, brackets, etc., before passing it on; however, this stripping routine has been removed in the present specific implementation of the presently preferred embodiment because the IP telephony program may use some of these separator characters to properly interpret the telephone number it represents.

We return now to the Telephony BHO, which is waiting and listening in step 450 to any BeforeNavigate events that occur in the web browser. If a BeforeNavigate event is heard by the Telephony BHO in step 450, the Telephony BHO intercepts the URL to which the web browser is navigating to determine, in step 452, if it is a phone URL generated by the dial( ) function in the Javascript code. If the Telephony BHO determines that it is a phone URL in step 452, the Telephony BHO extracts the number string from the phone URL and sends the number string to the IP Telephony program in step 454. After these steps, the Telephony BHO and the Javascript code return to waiting.

The components in the method of FIGS. 4A and 4B are shown in FIG. 5. The Internet Explorer web browser 510 is shown in FIG. 5 next to the Telephony BHO 520 that was loaded when that instance of IE browser 510 was created. When Telephony BHO 520 hears a DocumentComplete event 515, the Telepony BHO 520 inserts the Javascript code 530 into the run-time DOM of the downloaded page 511. When a highlighted telephone number is clicked by the user, the Javascript code 530 creates the phone URL 537, which is captured by the generated BeforeNavigate event 517. Telephony BHO 520 hears the BeforeNavigate event 517, intercepts the phone URL 537, and sends the phone number to IP Telephony program 550.

Earlier, in the description of step 434 in FIG. 4A, it was mentioned that the Javascript code inserted into the run-time DOM of the downloaded page parsed the objects in the run-time DOM looking for anything that resembled a telephone number. This and other details of the Javascript code will be described below. Before that, however, it should be noted that specific parsing implementation described below is only one of a myriad of possible search methods possible in implementing the present invention. In the specific implementation of the presently preferred embodiment, additional search parameters are used when searching for instances of telephone numbers. Certain terms, such as “telephone”, “phone”, “mobile”, “cell”, and “fax”, whose presence indicates an increased likelihood of a telephone number, are looked for in the vicinity of any numbers. In other implementations, additional terms (or icons representing the same) may be searched for. Search parameters such as these are under the control of the user, e.g., the user may define words or terms to look for, or the user may have the ability to turn on and off certain search parameters, by the user, etc.

Returning to the detailed description of the Javascript code in the specific implementation of the presently preferred embodiment, the entry point into the Javascript code is the mainFuncFN( ) function, which is called by the Telephony BHO 520, as was mentioned above. The mainFuncFN( ) function calls the parsePhoneNums( ) function, which in turn calls a match( ) function, which contains the regular expressions developed to recognize telephone numbers on downloaded documents. Two regular expression strings, adopted from Perl, have been developed for use in the present specific implementation of the presently preferred embodiment. The first expression string captures the formats associated with North American based numbers and the second expression string captures the international formats.

The following characteristics were used to define North American based telephone numbers:
a) The area code is 3 digits and can sometimes be in brackets;
b) The subscriber number is seven digits long and is clustered into two groups comprised of a first group of three digits and a second group of four digits;
c) The two groups are separated by one of a space, dash, dot, or a middle dot, or are not separated at all;
d) The area code and the subscriber number are separated by one of a space, dash, dot, or a middle dot, or not separated at all;
e) The phone numbers may begin with a + character followed by the digit 1, the + character followed by a space and then the digit 1; and
f) The optional ‘+1’ and ‘+1’ in (e) can be separated from the 10 digit phone numbers with one of a space, a dash or a dot.

An example of a regular expression string which satisfies the above characteristics is:
[symbol] +? ?1? ?−?\.?\(?\d{3}\)?\·?−?\.? ?\d{3}−?.?\·? ?\d{4}/gi

The regular expression string is bounded by the “/” character. Next the \+ matches the + character. The plus has a “\” in front to specify we mean an actual “+” character and not the special character. This is followed by the “?” character which means that it matches zero or one instance of the “+” character. This is followed by the space and “?” character which matches zero or one instance of a space character. The rest of the regular expression captures the characteristics that we desire to capture. At the end the “g” character indicates that a global match be performed to get all instances of such pattern and the “i” character makes the match case insensitive.

The international numbers can be quite varied in format and it was discovered to be best if the parsing was limited to the characteristics described below:
a) The number begins with a “+” character, followed by 1 to 3 digits which signifies the country code, then followed by an optional space character;
b) A 1 to 5 digit string comprises the area code and can sometimes be in brackets; and
c) The 1-5 digit areo code is followed by four groups of digits, in which the groups are separated by a zero or one instance of a space character.

An example of a regular expression string which satisfies the above characteristics is:
/(\+\d{1,3} ?)(\(\d{1,5}\)|\d{1,5}) ?\d{1,6} ?\d{0,7} ?\d{0,5} ?\d{0,5}/gi;

With these two examples, it should be clear how such a string can be written and how the parsing can be performed. The same principles may be used in a similar manner to implement parsing in order to detect other types of data on any type of downloaded markup language document in a browser.

It should be kept in mind that FIGS. 4A, 4B, 5, and the above discussion concerning the Javascript code only refer to a specific implementation of the presently preferred embodiment. In other words, the presently preferred embodiment, as described above with reference to FIGS. 2 and 3B-3E, may be implemented in a large variety of ways, as would be known to one skilled in the art. For example, the functionality of the Javascript code could be in another appropriate programming language, e.g., VBScript, Perl, etc. Furthermore, the functionality of the Javascript code could be part of the Telephony BHO. In a similar manner, the functionality of the Telephony BHO could be achieved through other means, e.g., a browser plug-in, or, specifically in Internet Explorer, ActiveX controls (in this respect, it should be noted that the use of the BHO/Javascript combination in the present specific implementation of the presently preferred embodiment eliminates many of the problems inherent in the use of ActiveX controls).

While there have shown and described and pointed out fundamental novel features of the invention as applied to a preferred embodiment thereof, it will be understood that various omissions and substitutions and changes in the form and details of the method steps described, the devices illustrated, and the operation thereof, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for automatically detecting a specified type of data in a markup language document and for providing functionality for any detected instances of the specified data type in the markup language document, comprising the steps of:
loading the markup language document into a browser capable of visually rendering the markup language document;
automatically identifying any instances of the specified type of data in the markup language document;
visually rendering the loaded markup language document, wherein said step of visually rendering the loaded markup language document comprises the step of:
visually rendering any identified instances of the specified data type in the loaded markup language document such that each one of any identified instances stands out visually in the visually rendered markup language document; and
providing a functionality for performing or initiating a desired operation either with or upon any of the identified instances standing out in the visually rendered markup language document, wherein said functionality comprises the step of:
in response to only a single action being performed by a user of the browser in relation to any of the identified instances standing out in the visually rendered markup language document, performing or initiating a desired operation either with or upon any of the identified instances standing out in the visually rendered markup language document.

2. The method of claim 3, wherein the single action performed by the user of the browser comprises the step of:
selecting at least one of the identified instances standing out in the visually rendered markup language document.

3. The method of claim 2, wherein said step of selecting comprises the step of:
using a cursor and a selecting means to click the at least one of the identified instances standing out in the visually rendered markup language document.

4. The method of claim 3, wherein said selecting means comprises at least one of a computer mouse, a touchpad, a keyboard, a trackball, a voice command device, and a joystick.

5. The method of claim 1, wherein the desired operation comprises at least one of storing any of the identified instances of the specified data type in at least one memory location designated for the specified type of data; transmitting any of the identified instances of the specified data type to a designated piece of hardware or software in order that the designated piece of hardware/software perform a desired action either with or upon any of the identified instances of the specified data type; and providing the user of the browser with a number of options of what action to perform with or upon any of the identified instances of the specified data type.

6. The method of claim 1, wherein said steps of loading the markup language document into the browser and automatically identifying any instances of the specified type of data in the markup language document are performed at substantially the same time.

7. The method of claim 1, wherein the specified data type comprises at least one of a category of text, a category of picture file, a category of audio file, and an attribute of a picture or audio file.

8. The method of claim 7, wherein the category of text is at least one of a telephone number and a mailing address.

9. The method of claim 1, wherein the step of visually rendering any identified instances of the specified data type in the loaded markup language document such that each one of any identified instances stands out visually in the visually rendered markup language document comprises the step of:
highlighting each one of any identified instances in the visually rendered markup language document.

10. The method of claim 1, wherein the markup language comprises at least one of HTML and XML.

11. A method for automatically detecting a specified type of data in an HTML or XML document (HTML/XML document) and for performing or initiating a desired operation either with or upon at least one selected instance of the specified data type in the HTML/XML document, comprising the steps of:
loading the HTML/XML document into a browser of HTML/XML documents (HTML/XML browser);
automatically detecting any instance of the specified data type in the HTML/XML document;
displaying the loaded HTML/XML document in the HTML/XML browser;
highlighting any detected instance of the specified data type in the displayed HTML/XML document; and
when a user of the HTML/XML browser selects at least one highlighted instance of the specified data type in the displayed HTML/XML document, performing or initiating a desired operation either with or upon said at least one selected instance of the specified data type.

12. The method of claim 11, wherein the step of detecting any instance of the specified data type in the HTML/XML document comprises the step of:
parsing a run-time Document Object Model (DOM) of the HTML/XML document.

13. The method of claim 12, wherein the step of parsing a run-time Document Object Model (DOM) of the HTML/XML document comprises the step of:
inserting programming code into the run-time DOM of the HTML/XML document, wherein said inserted programming code parses the run-time DOM.

14. The method of claim 13, wherein the inserted programming code parses the run-time DOM using at least one expression string, wherein said at least one expression string describes the object characteristics of the specified data type.

15. The method of claim 14, further comprising the steps of:
receiving feedback from the user concerning an undetected instance of the specified data type; and
using the user feedback in order to detect said undetected instance in the future, by performing at least one step of:
modifying the at least one expression string; and
adding at least one other expression string.

16. The method of claim 11, wherein the step of highlighting any detected instance of the specified data type in the displayed HTML/XML document comprises the step of:
placing a span tag at any detected instance of the specified data type in the displayed HTML/XML document, wherein said span tag also makes the detected instance selectable by the user.

17. The method of claim 11, wherein the step of performing or initiating a desired operation either with or upon said at least one selected instance of the specified data type comprises the step of:
extracting said at least one selected instance of the specified data type.

18. The method of claim 17, wherein the step of performing or initiating a desired operation either with or upon said at least one selected instance of the specified data type further comprises the step of at least one of:
passing the extracted at least one selected instance of the specified data type to another program;
storing the extracted at least one selected instance of the specified data type; and
transmitting the extracted at least one selected instance of the specified data type to another software or hardware component in a computer system or network, wherein the HTML/XML browser is running on a component of said computer system or network.

19. The method of claim 11, wherein user of the HTML/XML browser selects at least one highlighted instance of the specified data type in the displayed HTML/XML document by performing only a single action.

20. The method of claim 11, wherein the user may use one of at least two techniques to select at least one highlighted instance of the specified data type in the displayed HTML/XML document.

21. The method of claim 20, wherein, if a first of the at least two selection techniques is used by the user to select at least one highlighted instance of the specified data type, a menu of selectable options is presented to the user, wherein the selectable options comprise desired operations to perform or initiate with or upon the selected at least one highlighted instance of the specified data type.

22. A method for assisting a user in calling or storing a telephone number on a web page downloaded in a web browser, said web page comprising HTML or XHTML, comprising the steps of:
automatically detecting any instance of a telephone number in a downloaded web page;
providing functionality that (i) highlights any detected telephone number in the downloaded web page; and (ii) allows the user to select any highlighted detected telephone number in the downloaded web page;
if the user selects a highlighted detected telephone number, extracting the selected highlighted telephone number; and
at least one of:
passing the extracted telephone number to a telephony program in order that the telephony program initiate a telephone call; and
storing the extracted telephone number in memory.

23. The method of claim 22, wherein the step of automatically detecting any instance of the specified data type in the downloaded web page comprises the step of:
inserting programming code into the run-time Document Object Model (DOM) of the downloaded web page, wherein said inserted programming code parses the run-time DOM of the downloaded web page.

24. The method of claim 23, wherein the inserted programming code parses the run-time DOM using at least one expression string, wherein the at least one expression string describes at least one of North American formatted telephone numbers and international formatted telephone numbers.

25. The method of claim 24, further comprising the steps of:
receiving feedback from the user concerning an undetected telephone number on the downloaded web page; and
using the user feedback in order to detect a format of said undetected telephone number in the future, by performing at least one step of:
modifying the at least one expression string; and
adding at least one other expression string.

26. The method of claim 21, wherein the step of providing functionality that (i) highlights any detected telephone number in the downloaded web page; and (ii) allows the user to select any highlighted detected telephone number in the downloaded web page comprises the step of:
placing a span tag at a detected instance of telephone number in the downloaded web page, wherein said span tag (i) highlights the detected telephone number in the displayed web page; and (ii) makes the highlighted detected telephone number in the displayed web page selectable by the user.

27. The method of claim 22, wherein the steps of automatically detecting any instance of a telephone number and providing functionality that (i) highlights any detected telephone number in the downloaded web page; and (ii) allows the user to select any highlighted detected telephone number in the downloaded web page are performed by at least one of a proxy server and a client browser.
